(19) United States
(12) Patent Application Publication
(10) Pub. No.: US 2016/0071064 A1
(43) Pub. Date: Mar. 10, 2016

(54) CONTEXT DRIVEN TASK CREATION AND MANAGEMENT

(71) Applicant: SugarCRM Inc., Cupertino, CA (US)

(72) Inventors: Majed Itani, San Jose, CA (US); Dmitriy Kolegayev, West Hollywood, CA (US)

(21) Appl. No.: 14/479,295

(22) Filed: Sep. 6, 2014

(51) Int. Cl. G06Q 10/10

(52) U.S. Cl. CPC G06Q 10/1093

(57) ABSTRACT

Embodiments of the invention provide a method, system and computer program product for the contextually driven creation and management of tasks in a calendaring and scheduling (C&S) application. In an embodiment of the invention, a method of contextually driven creation and management of tasks in a C&S application is provided. The method includes detecting an action in a C&S application, such as the receipt of a message or the completion of a task already existing in the C&S application. The method also includes determining a context for the action and identifying a set of rules each matching the determined context and also selecting a rule as a highest priority rule amongst the set of rules. Finally, the method includes applying the selected rule to create a task in the C&S application.

### STATEMENT OF RELATED APPLICATIONS

The present invention relates to the presently co-pending U.S. patent application having Ser. No. 14/060,704 filed on Oct. 23, 2013 entitled Automation of customer relationship management (CRM) tasks responsive to electronic communications.

### BACKGROUND OF THE INVENTION

1. Field of the Invention

The present invention relates to task management in a calendaring and scheduling (C&S) system and more particularly to context driven task creation and management in a C&S system.

2. Description of the Related Art

Tasks are to-dos that are recorded in a C&S system to remind the end user to complete the task at some point in the future. A task list is a list of tasks which are to be completed by the end user and, within a C&S system, may be ordered within a list alphabetically, chronologically in terms of task creation, or in order of assigned priority. In this regard, as tasks can be numerous within a task list, in an effort to assist the end user in determining a particular order in which tasks are to be completed, each task in a task list can be assigned a priority from amongst a range of priorities. In this way, the likelihood of an end user completing an important task can be increased.

The prioritization of only a few tasks in a task list can be a relatively management project, however, as tasks become numerous within a task list, properly assigning a priority to each task can be challenging. In this regard, where an end user manages dozens of tasks, assigning an appropriate priority to a new task relative to existing tasks can be nearly impossible and requires the end user to consider the assigned priority of each existing task in the task list. As and end result, managing a large task list can become a task in unto itself.

Of note, tasks in a task list do not exist in isolation. Rather, tasks can be logically related and the completion of one task may affect the creation of a new task, or the prioritization of an existing task. Yet, the knowledge of “what to do next” is largely held in the mind of the end user and for the busy end user, recalling a next task can be overly burdensome. The problem of knowing “what to do next” can be of particular concern in the field of CRM in a CRM application in which the failure to schedule a task can result in a failure to adequately service a customer and can damage the customer vendor relationship intended to be safeguarded through the use of a CRM application.

### BRIEF SUMMARY OF THE INVENTION

Embodiments of the present invention address deficiencies of the art in respect to task management and provide a novel and non-obvious method, system and computer program product for the contextually driven creation and management of tasks in a C&S application. In an embodiment of the invention, a method of contextually driven creation and management of tasks in a C&S application is provided. The method includes detecting an action in a C&S application, such as the receipt of a message or the completion of a task already existing in the C&S application. The method also includes determining a context for the action and identifying a set of rules each matching the determined context and also selecting a rule as a highest priority rule amongst the set of rules. Finally, the method includes applying the selected rule to create a task in the C&S application. In one aspect of the embodiment, the rule in the set of rules is promoted to a higher priority responsive to a determination of a threshold number of tasks created by the rule having been completed by one or more end users of the C&S application.

In another embodiment of the invention, a C&S data processing system is provided. The system includes a server computing system comprising at least one computer with memory and at least one processor and coupled to different client computers over a computer communications network. The system also includes a CRM application executing in the server computing system and storing tasks in a data store coupled to the server computing system. Finally, the system includes a task creation and management module executing in the memory of the server computing system. The module includes program code enabled to detect an action in the CRM application, to determine a context for the action, to identify a set of rules each matching the determined context, to select a rule as a highest priority rule amongst the set of rules, and to apply the selected rule to create a task in the CRM application.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for the contextually driven creation and management of tasks in a C&S application;

FIG. 2 is a schematic illustration of a C&S data processing system configured for contextually driven creation and management of tasks; and,

FIG. 3 is a flow chart illustrating a process for the contextually driven creation and management of tasks in a C&S application.

FIG. 4 is a flow chart illustrating a process for the adaptive prioritization of rules in the rule set of FIG. 3.

FIG. 5 is a screen shot of tasks created according to the rule set of FIG. 3 and organized by prioritization managed according to the process of FIG. 4.

### DETAILED DESCRIPTION OF THE INVENTION

Embodiments of the invention provide for contextually driven creation and management of tasks. In accordance with an embodiment of the invention, a message can be received in a messaging component of an application and a context for the message can be determined. A set of rules based upon context can be loaded and one or more of the rules in the set selected according to the context determined for the message. Each of the rules can trigger the creation of a task in a task management component of the application, the prioritization of an existing task in the task management component, or the creation and prioritization of a new task in the task management component. Of note, the rules in the set also can be prioritized and selectively triggered according to prioritization. Thereafter, the selected rules can be triggered to create one or more tasks, to prioritize the created task or tasks, to prioritize one or more existing tasks, or any combination thereof. Optionally, the prioritization of the rules can vary according to observed utilization of tasks created by the prioritized rules. In this way, the question of “what to do next” can be answered in an autonomic fashion.

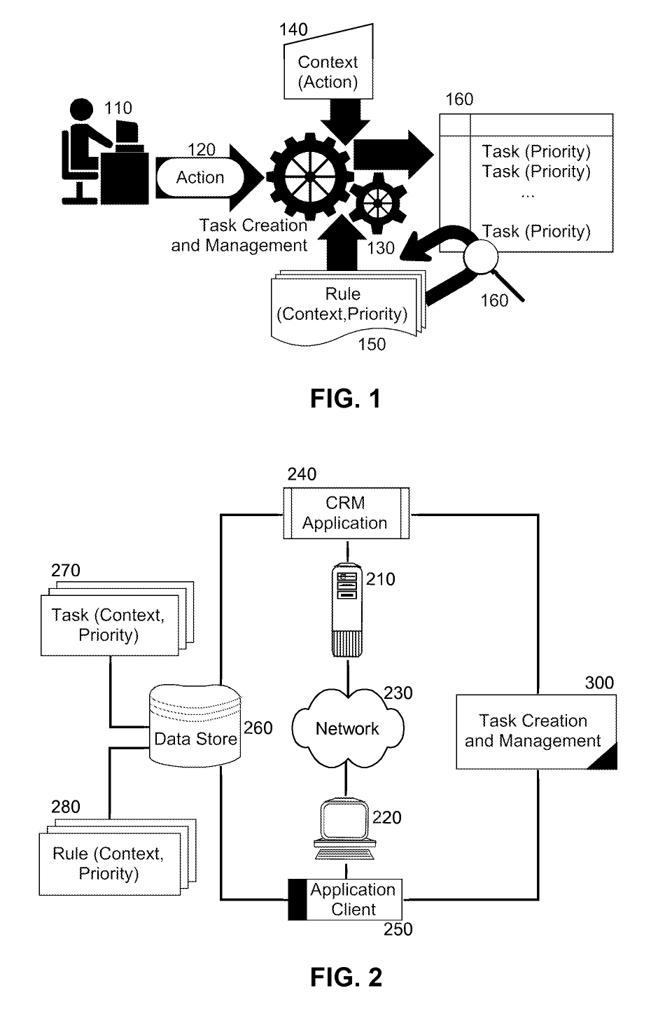

In illustration, FIG. 1 pictorially shows a process for the contextually driven creation and management of tasks in a C&S application. As shown in FIG. 1, an end user utilizing a C&S application such as that included as part of a CRM system can perform an action 120 with respect to the C&S application. The action 120 can include, by way of example, the completion of a task, the failure to complete a task at a designated time, the rescheduling of a task, the reassignment of a task from the end user to a different end user or group of end users, the receipt of a message such as an e-mail, the scheduling of a meeting in the C&S application, to name only a few.

In response to the occurrence of the action 120, task creation and management logic 130 can determine a context 140 for the action 120. The context 140 can include an identity of an end user providing a message, the identity of one or more end users referenced by a message, scheduled task or scheduled meeting, one or more keywords disposed within a message, or a task or meeting, a time of day or day of week, associated with a message, task or meeting, to name only a few examples. Once the logic 130 has determined the context 140 for the action 120, one or more applicable rules 150 can be located for the context 140 and applied in order of priority assigned to each of the rules 150.

In this regard, each of the rules 150 can specify a task 160 to be created for the end user 110 or, optionally, for another end user, in response to an action of a particular context. Each of the rules 150 also can specify for a created one of the tasks 160 a priority. For example, one of the rules 150 may specify that in response to an e-mail message from an existing customer, a medium priority task is to be created to initiate a telephone call to the customer by a service agent assigned to the customer. As another example, one of the rules 150 may specify that in response to detecting within an e-mail message the term “quote”, a high priority task is to be created to initiate a telephone call to the sender of the e-mail message by a sales representative. As yet another example, in response to detecting the completion of a task relating to the closing of a trouble ticket for a customer by a technical support specialist that relates to an outdated version of a product, a low priority task is to be created to send an e-mail message to the customer by a sales representative providing information on a latest version of the product.

Of note, the task creation and management logic 130 can monitor the utilization of the tasks 160 in order to dynamically re-prioritize the rules 150. Specifically, as an individual one of the tasks 160 is completed, the task creation and management logic 130 can determine a corresponding one of the rules 150 responsible for the creation of the individual one of the tasks 160. In response to a determination of a threshold or proportionate number of completions of the individual one of the tasks 160 created by the corresponding one of the rules 150, the corresponding one of the rules 150 can be promoted in priority indicative of the relative applicability of the corresponding of the rules 150. Conversely, in response to a determination of a failure to reach a threshold or proportionate number of completions of the individual one of the tasks 160 created by the corresponding one of the rules 150, the corresponding one of the rules 150 can be demoted in priority indicative of the relative inapplicability of the corresponding of the rules 150.

The process described in connection with FIG. 1 can be implemented within a C&S data processing system supporting a CRM application. In yet further illustration, FIG. 2 schematically shows a C&S data processing system configured for contextually driven creation and management of tasks for a CRM application. More particularly, the system can include a server computing system 210 that includes one or more computers, each with at least one processor and memory and supporting the operation of a CRM application 240. The server computing system 210 can be coupled over computer communications network 230 to a client computer 220 with at least one processor and memory and supporting the operation of an application client 250 accessing the CRM application 240.

The CRM application 240 and the application client 250 can access a data store 260 disposed in either or both of the server computing system 210 and the client computer 220. The data store 260 can include a set of tasks 270. Each of the tasks 270 can be associated with a particular context in which the task had been created as well as a priority relative to the priorities of others of the tasks 270. The data store 260 also can include a set of rules 280. Each of the rules 280 can include a priority relative to the priority to others of the rules 280, as well as an associated context in which the rule is to be applied.

Of note, a task creation and management module 300 can be coupled to either or both of the CRM application 240 and the application client 250. The module 300 can include program code that when executed in the memory of the server computing system 210 or the client computer 220 is enabled to a detect an action in the CRM application 240, such as the receipt of a message or the completion of a task, and to respond to the detection of the action by determining a context for the action and selecting one or more of the rules 280 based upon context. Thereafter, the program code of the module 300 can be enabled to apply one or more of the selected rules 280 in order of priority of the selected rules 280 so as to create one or more tasks 270 in the data store 260.

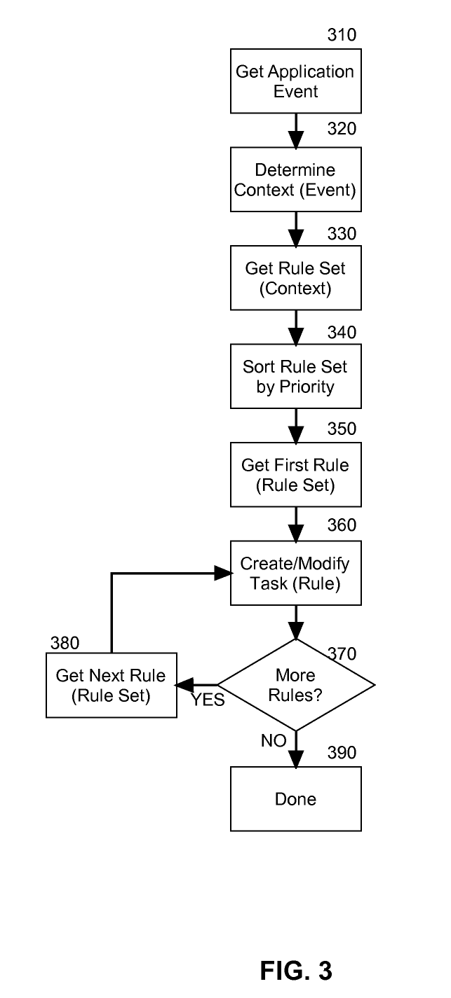

In yet further illustration of the operation of the task creation and management module 300, FIG. 3 is a flow chart illustrating a process for the contextually driven creation and management of tasks in a CRM application. Beginning in block 310, an application event can be detected that is indicative of an action such as a received message or a task marked completed. In block 320, a context for the event can be determined, for instance an identity of an end user providing a message, the identity of one or more end users referenced by a message, scheduled task or scheduled meeting, one or more keywords disposed within a message, or a task or meeting, a time of day or day of week, associated with a message, task or meeting, to name only a few examples.

In block 330, a set of rules can be identified which had previously been mapped to the determined context. In block 340, the set of rules can be sorted according to priority and in block 350 a first of the rules in the set can be selected. In block 360, the selected rule can be applied so as to create a new task or modify an existing task as specified by the selected rule. Subsequently, in decision block 370 if additional rules remain to be processed in the set, in block 380 a next rule in the set can be selected. The selected rule once again can be applied in block 360 so as to create a new task or modify an existing task as specified by the selected rule. In decision block 370, when no further rules in the set remain to be processed, the process can end in block 390.

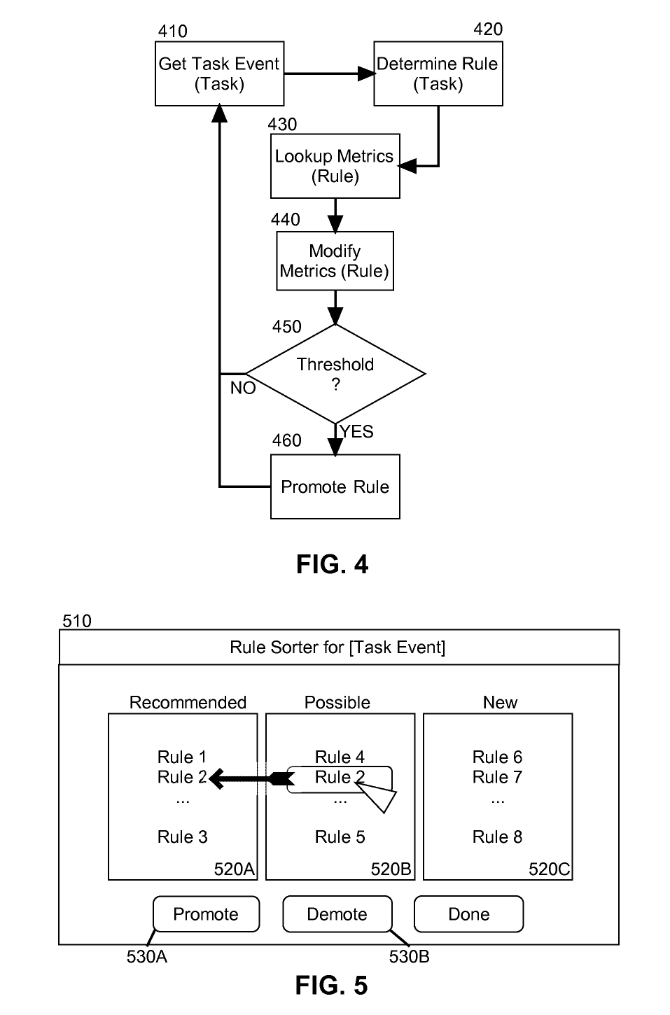

Optionally, the task creation and management module 300 of FIG. 3 can be enabled to dynamically prioritize each of the rules based upon the observed utilization of tasks created by the rules. In even yet further illustration, FIG. 4 is a flow chart illustrating a process for the adaptive prioritization of rules in the rule set of FIG. 3. Beginning in block 410, an event for a task can be detected, such as the completion of a task, the removal (deletion) of a task, the rescheduling of a task or the reassignment of a task to a different end user. In block 420, a rule responsible for the creation of the task can be identified and in block 430, utility metrics for the rule can be determined—specifically, a number of tasks that have been completed that are the result of the rule. In block 440, the metrics for the rule can be modified to account for the event. Thereafter, in decision block 450, it can be determined whether or not a threshold number of tasks created by the rule have been completed. If so, in block 460 the rule can be promoted in priority. Subsequently, the process can repeat in block 410.

Optionally, the end user can be afforded an opportunity to manually visualize and prioritize the different rules of the rule set for a selected task in the CRM application. In even yet further illustration, FIG. 5 is a screen shot of tasks created according to the rule set of FIG. 3 and organized by prioritization managed according to the process of FIG. 4. As shown in FIG. 5, a rule sorter 510 can be provided in which rules 520A, 520B, 520C of differing priorities can be presented in accordance with respective relative priorities. In the exemplary user interface, three priorities can be provided: recommended rules, possible rules and new rules. Recommend rules are rules of a highest priority known to have resulted in a past greatest utilization by end users. Possible rules are rules of a medium priority based upon some utilization by end users previously. New rules are rules yet to have produced tasks experiencing a threshold utilization by end users. The end user may select a given rule in the rule sorter 510 and by activation of promotion and demotion controls 530A, 530B, manually promote the priority of the selected rule.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method of contextually driven creation and management of tasks in a calendaring and scheduling (C&S) application comprising:
detecting an action in a C&S application executing in memory of a computing system;
determining a context for the action;
identifying a set of rules each matching the determined context and selecting a rule as a highest priority rule amongst the set of rules; and,
applying the selected rule to create a task in the C&S application.

2. The method of claim 1, wherein the action is a receipt of a message.

3. The method of claim 1, wherein the action is a completion of a task already existing in the C&S application.

4. The method of claim 2, wherein the context is a sender of the message.

5. The method of claim 2, wherein the context is a keyword present in the message.

6. The method of claim 1, wherein the rule specifies a creation of the task in the C&S application in response to the occurrence of the action with the determined context.

7. The method of claim 1, wherein a rule in the set of rules is promoted to a higher priority responsive to a determination of a threshold number of tasks created by the rule having been completed by one or more end users of the C&S application.

8. The method of claim 1, wherein the C&S application is included as part of a customer relationship management (CRM) system.

9. A calendaring and scheduling (C&S) data processing system comprising:
a server computing system comprising at least one computer with memory and at least one processor and coupled to different client computers over a computer communications network;
a customer relationship management (CRM) application executing in the server computing system and storing tasks in a data store coupled to the server computing system; and,
a task creation and management module executing in the memory of the server computing system, the module comprising program code enabled to detect an action in the CRM application, to determine a context for the action, to identify a set of rules each matching the determined context, to select a rule as a highest priority rule amongst the set of rules, and to apply the selected rule to create a task in the CRM application.

10. The system of claim 9, wherein the action is a receipt of a message.

11. The system of claim 9, wherein the action is a completion of a task already existing in the CRM application.

12. The system of claim 10, wherein the context is a sender of the message.

13. The system of claim 10, wherein the context is a keyword present in the message.

14. The system of claim 10, wherein the rule specifies a creation of the task in the CRM application in response to the occurrence of the action with the determined context.

15. The system of claim 9, wherein a rule in the set of rules is promoted to a higher priority responsive to a determination of a threshold number of tasks created by the rule having been completed by one or more end users of the CRM application.

16. A computer program product for contextually driven creation and management of tasks in a calendaring and scheduling (C&S) application, the computer program product comprising:
a computer readable storage medium having computer readable program code embodied therewith, the computer readable program code comprising:
computer readable program code for detecting an action in a C&S application executing in memory of a computing system;
computer readable program code for determining a context for the action;
computer readable program code for identifying a set of rules each matching the determined context and selecting a rule as a highest priority rule amongst the set of rules; and,
computer readable program code for applying the selected rule to create a task in the C&S application.

17. The computer program product of claim 16, wherein the action is a receipt of a message.

18. The computer program product of claim 16, wherein the action is a completion of a task already existing in the C&S application.

19. The computer program product of claim 17, wherein the context is a sender of the message.

20. The computer program product of claim 17, wherein the context is a keyword present in the message.

21. The computer program product of claim 16, wherein the rule specifies a creation of the task in the C&S application in response to the occurrence of the action with the determined context.

22. The computer program product of claim 16, wherein a rule in the set of rules is promoted to a higher priority responsive to a determination of a threshold number of tasks created by the rule having been completed by one or more end users of the C&S application.

23. The computer program product of claim 16, wherein the C&S application is included as part of a customer relationship management (CRM) system.
